(19) United States
(12) Patent Application Publication
(10) Pub. No.: US 2026/0146000 A1
(43) Pub. Date: May 28, 2026

(54) CONCRETE COMPOSITION FOR WATER TREATMENT STRUCTURE HAVING SELF-HEALING AND WATERPROOFING CAPABILITIES BY USING SELF-HEALING ADMIXTURE AND CONCRETE WATER TREATMENT STRUCTURE USING SAME

(71) Applicants: SAMSUNG E&A Co., Ltd., Seoul (KR); HUBCON Co., Ltd., Cheonan-si (KR)

(72) Inventors: Chang Youl LEE, Bucheon-si (KR); Sang Soo KIM, Goyang-si (KR); Kwang Myong LEE, Seoul (KR); Sung CHOI, Incheon (KR); Ji Young KIM, Seongnam-si (KR)

(21) Appl. No.: 18/986,576

(22) Filed: Dec. 18, 2024

(30) Foreign Application Priority Data
Nov. 28, 2024 (KR) 10-2024-0173590

(51) Int. Cl. C04B 20/12; C04B 14/02; C04B 18/08; C04B 20/10; C04B 22/00; C04B 22/06; C04B 22/14; C04B 24/04; C04B 24/28; C04B 24/38; C04B 28/08; C04B 103/60; C04B 111/20; C04B 111/27

(52) U.S. Cl. CPC C04B 20/12; C04B 14/022; C04B 18/08; C04B 22/00; C04B 22/066; C04B 22/143; C04B 24/04; C04B 24/287; C04B 24/38; C04B 28/08; C04B 20/1037; C04B 20/1048; C04B 20/123; C04B 2103/60; C04B 2111/2038; C04B 2111/27

(57) ABSTRACT

A concrete composition for a water treatment structure having self-healing and waterproofing capabilities by using a self-healing admixture and a concrete water treatment structure using the same. The concrete composition for the water treatment structure includes a cement and a self-healing admixture including blast furnace slag, fly ash, an expansive material, and gypsum powder.

### CROSS REFERENCE TO RELATED APPLICATION

The present application claims priority under 35 U.S.C. § 119 (a) to Korean Patent Application No. 10-2024-0173590, filed on Nov. 28, 2024, the entire contents of which are incorporated herein for all purposes by this reference.

### BACKGROUND

### 1. Technical Field

The present disclosure relates to a concrete composition for a water treatment structure, the concrete composition including an admixture capable of improving physical properties, for example, increasing compressive strength, improving chemical resistance, reducing a water permeability ratio, and increasing chloride attack resistance while reducing cracks and exhibiting self-healing capability, and to a concrete water treatment structure using the same.

### 2. Description of the Related Art

Cracks may occur in concrete used in construction sites due to several factors caused during production and construction processes. Concrete water treatment structures with such unavoidable defect factors must be waterproofed.

Waterproof coating has been relatively widely used to waterproof existing water treatment structures. In this case, coating films such as urethane, sheet, fiberglass reinforced plastic (FRP), and the like are installed outside concrete. For this reason, the water inside a tank does not make direct contact with the concrete at the beginning of construction. Therefore, even when the concrete substrate is defective, the waterproofing capability can be exhibited due to the sealing effect. However, such coating films for sealing are primarily made of organic matter, making integrated construction with inorganic concrete challenging, and coating films are damaged over a long time, which is problematic. Therefore, concrete structures with a long service life require ongoing maintenance to maintain waterproofing capability.

However, in the case of water treatment structures or structures buried underground, maintenance by the waterproof coating mentioned above is challenging due to the constant presence of moisture. To address the challenge associated with such structures, there are cases where concrete waterproofing agents having waterproofing capability are used concurrently in concrete substrates. However, it is difficult to expect such concrete waterproofing agents to exhibit effective waterproofing capability when defects such as cracks and construction joints occur in concrete substrates. In addition, when moisture infiltrates concrete substrates as described above, concrete durability may deteriorate faster than expected. Especially for water treatment structures that may cause chemical erosion, such as sewage and wastewater, it is essential to establish measures that can reinforce durability.

In the meantime, although ordinary Portland cement has autogenous healing properties, meaning that cracks are healed autogenously, it is known that the capability of cement itself is insufficient to effectively heal cracks occurring in concrete because the crack healing capability based on autogenous healing is insignificant, only effective for crack width of 0.1 mm or smaller.

As one example existing in the art, Korean Patent No. 10-2187932 has proposed a self-healing concrete including an inorganic self-healing material formulated with ordinary Portland cement, wherein the inorganic self-healing material is a nanocalcite. The nanocalcite is formulated in an amount range of 0.5% to 0.9% by weight, and the self-healing concrete obtains self-healing capability for crack width of 0.25 mm or greater.

However, despite providing some degree of self-healing, the above technology itself has limitations in fulfilling sufficient physical properties such as crack resistance, chemical resistance, and the like, which is problematic.

### DOCUMENT OF RELATED ART

### Patent Document

Korean Patent No. 10-2187932

### SUMMARY

Therefore, to address the problems described above, the present disclosure aims to provide a concrete composition for a water treatment structure, the concrete composition including an admixture capable of improving physical properties such as compressive strength, chemical resistance, and the like while reducing the occurrence of cracks and enabling cracks occurring over time to be healed. In addition, the present disclosure aims to provide a concrete water treatment structure using the concrete composition.

To achieve the objectives described above, a concrete composition for a water treatment structure of the present disclosure (hereinafter referred to as the “composition of the present disclosure”) having self-healing and waterproofing capabilities by using a self-healing admixture, is characterized by including: a cement; and a self-healing admixture including blast furnace slag, fly ash, an expansive material, and gypsum powder.

The water treatment structure herein is any structure constructed using the composition of the present disclosure, and the types thereof are not limited.

In addition, disclosed herein is a concrete water treatment structure using the composition of the present disclosure.

As described above, a composition of the present disclosure has advantages that crack resistance and self-healing capability in the occurrence of cracks afterward can be exhibited, and the service life in terms of durability can be extended by improving physical properties such as chemical resistance, compressive strength, water tightness, and the like.

### BRIEF DESCRIPTION OF THE DRAWINGS

FIG. 1 is a graph showing experimental values of compressive strength for Examples 1 to 8 according to an embodiment of present disclosure;

FIG. 2 is a graph showing experimental values of flow for Examples 1 to 8 according to an embodiment of present disclosure;

FIG. 3 is a graph showing experimental values of length change rates for Examples 1 to 8 according to an embodiment of present disclosure;

FIG. 4 is a graph showing experimental values of chloride attack resistance for Examples 1 to 8 according to an embodiment of present disclosure; and

FIG. 5 is a graph showing experimental results of healing efficiency for a crack width of 0.3 mm according to an embodiment of present disclosure.

### DETAILED DESCRIPTION

Embodiments of the present disclosure can be modified in many different forms, so the scope of the present disclosure does not state or imply any limitations of the present disclosure but rather describes common methods that may be utilized through the present disclosure. Thus, the present disclosure is not limited to the following embodiments.

A composition of the present disclosure is characterized by including: a cement; and a self-healing admixture including blast furnace slag, fly ash, an expansive material, and gypsum powder.

In addition to the components described above, the composition applicable to the present disclosure naturally includes water. Although the type of water is not limited, purified water that is free of impurities and clean is preferably used. In addition, the water-to-binder ratio (W/B), a value that determines the durability and strength of concrete, such as specified compressive strength, required average strength, and the like, is preferably in the range of 20% to 30% by weight to prevent drying shrinkage of concrete, segregation of materials, and the like.

In addition to the components described above, the composition applicable to the present disclosure further includes aggregates, and the aggregates include coarse aggregates and fine aggregates.

The coarse aggregates are also commonly referred to as gravels, and the type thereof is not limited as long as they are commonly used in the art. It is desirable that crushed aggregates or natural aggregates are used as the coarse aggregates, and those satisfying KS F 2502 or KS F 2527 are preferably used.

The fine aggregates, commonly referred to as sand, can typically be used in both fine and coarse forms. The fine form is preferably a material that passes almost completely through a No. 4 sieve (ASTM C125, 4.75 mm), and silica sand and the like are preferably used. The coarse form may be a material primarily retained on a No. 4 sieve (ASTM C125, 4.75 mm), and examples thereof preferably include silica sand, quartz, marble, granite, limestone, calcite, feldspar, alluvial sand, different types of durable sand such as other sand, or mixtures thereof. In the present disclosure, the sand percentage (S/a), which can be calculated as the volume ratio of sand(S) with respect to the total aggregates (sand and gravels, a), is also preferably in the range of 20% to 40% by volume to determine the fluidity of concrete.

The admixture is characterized by including blast furnace slag, fly ash, an expansive material, and gypsum powder.

Preferably, the admixture is characterized by including 50 to 150 parts by weight of fly ash, 5 to 30 parts by weight of the expansive material, and 5 to 30 parts by weight of gypsum powder, with respect to 100 parts by weight of blast furnace slag.

The blast furnace slag has latent hydraulic properties, that is, not being directly involved in reactions when making contact with water but being cured when making contact with hydroxyl ions, sulfates, and the like. Chemical activators have conventionally used to be added to induce the reaction of blast furnace slag, but there have been problems with secondary contamination resulting from the overuse of such chemical activators.

Accordingly, in the present disclosure, gypsum powder is added instead of chemical activators. This gypsum powder is added as a stimulant and thus is advantageous in environmental aspects.

It is reasonable to apply a sulfate type having a fineness in the range of 2500 to 4000 cm²/g, in which CaO accounts for 20% to 80%, and SO₃ accounts for 25% to 50%, as the gypsum powder.

The gypsum powder dissolves into Ca²⁺ and SO₄²⁻, where SO₄²⁻ heals cracks by forming ettringite, a needle-like hydrate, and monosulfate, a layered hydrate, while Ca²⁺ heals cracks by reacting with CO₃²⁻ to form calcium carbonate (CaCO₃).

Furthermore, in the present disclosure, a coating layer is applied on the outer periphery of the gypsum powder. This is to control the problem with the self-healing efficacy failing to be exhibited afterward due to the reaction of the gypsum powder with moisture in the storage and formulation processes.

In particular, the coating layer is characterized by including: an outer layer composed of a thermoplastic resin having a low melting point; and an inner layer including hydroxypropyl methylcellulose phthalate (HPMCP), acetic acid, hydrogenated polyterpene, and magnesium salts.

The thermoplastic resin having a low melting point, which constitutes the externally exposed outer layer, may be made of various known materials and may, for example, be formed by compositions including polyol and organic diisocyanate. Preferably, the outer layer is melted in a temperature range of 50° C. to 90° C., corresponding to the heat range of hydration.

Such configuration of the outer layer completely prevents the gypsum powder from being exposed to moisture in the storage process, and the heat of hydration generated during the formulation process eliminates the outer layer.

It is reasonable that in the inner layer being in contact with the outer periphery of gypsum, 20 to 100 parts by weight of acetic acid, 20 to 100 parts by weight of magnesium salts, and 5 to 10 parts by weight of hydrogenated polyterpene, with respect to 100 parts by weight of HPMCP, are preferably formulated.

The HPMCP functions as a film-forming agent and is a cellulose-based polymer with hydroxypropyl methylcellulose (HPMC) serving as the core structure.

The acetic acid is configured to improve adhesion to a surface, while the magnesium salts function as a stabilizing agent.

Such an inner layer, which is to delay the contact between the gypsum powder and moisture after when the outer layer is melted and eliminated in the formulation process, serves to control the premature reaction of the gypsum powder in the formulation process and the like so that the self-healing efficacy is multiplied in the occurrence of cracks afterward.

In particular, although the magnesium salts function as a stabilizing agent, when coming into contact with moisture due to the occurrence of cracks, brucite is produced as an expansive hydrate so that the crack healing efficacy by gypsum is multiplied. In other words, the magnesium salts are configured to enable the cracked parts to be further densely filled.

In addition, hydrogenated polyterpene is further added to the inner layer to allow early curing, thus enabling self-healing at the beginning. In other words, the hydrogenated polyterpene is configured to promote self-healing speed.

However, when such hydrogenated polyterpene is added, early curing may cause drying shrinkage cracks and the like on the interface of the crack healing parts due to water evaporation. Accordingly, one example that the inner layer further includes raffinose is proposed. Raffinose functions as a humectant to improve resistance to cracks on the interface, which are caused by drying shrinkage or the like mentioned above.

It is reasonable that 1 to 5 parts by weight of raffinose is formulated with respect to 100 parts by weight of HPMCP.

In the present disclosure, one example that the self-healing admixture further includes magnesia-carbon is also proposed. Magnesia-carbon (MgO—C) is a material that serves to form a seed for the self-healing admixture while functioning to form a highly active multi-lamellar structure by physical and chemical energy in the mechanochemical (MC) process.

Preferably, it is reasonable that 1 to 10 parts by weight of magnesia-carbon is formulated with respect to 100 parts by weight of blast furnace slag.

In the present disclosure, one example that a smectite clay mineral serving as the expansive material are used is also proposed. The smectite clay mineral is a clay mineral primarily composed of smectite, and one representative example thereof is bentonite. For example, Ca-based bentonite may be used. Such smectite clay minerals have the properties of absorbing/swelling moisture and thus help obtain the elution properties of calcium ions effective for self-healing through the absorbed moisture even without making ongoing contact with moisture.

In the present disclosure, one example that a polyanionic polymer serving as the expansive material is used is also proposed.

Alginate may be used as the polyanionic polymer.

When adding the smectite clay mineral as the expansive material, not only cations but also anions are adsorbed during the moisture absorption process. In this case, OH⁻ for producing calcium hydroxide in cement hydration reactions may be adsorbed and hinder the hydration reaction. Thus, in the present disclosure, the polyanionic polymer is added so that only cations such as calcium ions are selectively adsorbed during moisture absorption and expansion to control problems with a decrease in strength and the like.

In the meantime, workability may be poor in the present disclosure due to the addition of gypsum, which is problematic. In addition, while the self-healing efficacy is exhibited by gypsum, there may be problems with drying cracking caused by early curing, as mentioned above.

Accordingly, in the present disclosure, one example that the admixture further includes polyaspartate to improve resistance to drying cracking while improving the poor workability resulting from the addition of gypsum is further proposed.

In other words, the polyaspartate is added to improve dispersibility to improve workability, while resistance to drying cracking is improved by moisturizing.

However, when only the polyaspartate is added, the segregation of materials and the like result in a decrease in strength, which is problematic.

Accordingly, in the present disclosure, one example that abietic acid is further included in addition to the polyaspartate is proposed.

Abietic acid is added to control the decrease in strength and also to improve corrosion resistance.

Preferably, it is reasonable that 1 to 5 parts by weight of a mixture of the polyaspartate and abietic acid is formulated with respect to 100 parts by weight of blast furnace slag. In addition, it is reasonable that the polyaspartate and abietic acid are formulated in a weight ratio range of (7:3) to (9:1).

Examples of the present disclosure will be described through the following experimental examples.

Each sample was constructed as shown in Table 1 below, and each admixture was prepared to include 50 parts by weight of fly ash, 10 parts by weight of alginate, and 10 parts by weight of gypsum powder, with respect to 100 parts by weight of blast furnace slag. The experimental results for the compressive strength of each sample are shown in Table 2.

TABLE 1

Binder ratio (% by weight)

| Formulation type | Cement | Admixture |
|---|---|---|
| Comparative Example | 100 | — |
| S1 | 96 | 4 |
| S2 | 90 | 10 |
| S3 | 80 | 20 |

TABLE 2

| | Compressive strength at 28 days |
|---|---|
| Formulation type | MPa |
| Comparative Example | 42.2 |
| S1 | 50.8 |
| S2 | 52.6 |
| S3 | 52.0 |

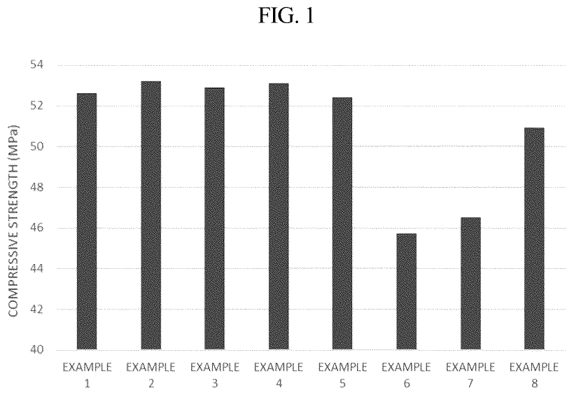

As shown in the above experimental results, it is seen that S2 has the best compressive strength. Accordingly, experiments for compressive strength, flow, length change rates, chloride attack resistance, and crack healing efficiency were conducted using the binder including 10% by weight of the admixture with respect to 90% by weight of the cement. The experimental results thereof are shown in FIGS. 1 to 5 and Table 3 below.

### Example 1

An admixture was formulated to include 50 parts by weight of fly ash, 10 parts by weight of alginate, and 10 parts by weight of gypsum powder, with respect to 100 parts by weight of blast furnace slag, thereby preparing a sample.

### Example 2

An admixture was formulated to include 50 parts by weight of fly ash, 10 parts by weight of alginate, 10 parts by weight of gypsum powder, and 2 parts by weight of magnesia-carbon, with respect to 100 parts by weight of blast furnace slag, thereby preparing a sample.

### Example 3

A sample was prepared in the same manner as in Example 1 by formulating an admixture, except for applying a coating layer including an outer layer composed of a thermoplastic resin (polyol) having a low melting point and an inner layer in which 50 parts by weight of acetic acid and 30 parts by weight of magnesium salts, with respect to 100 parts by weight of HPMCP, were formulated, on each of the gypsum powders.

### Example 4

A sample was prepared in the same manner as in Example 3 by formulating an admixture, except for applying a coating layer including an outer layer composed of a thermoplastic resin (polyol) having a low melting point and an inner layer in which 50 parts by weight of acetic acid, 30 parts by weight of magnesium salts, and 5 parts by weight of hydrogenated polyterpene, with respect to 100 parts by weight of HPMCP, were formulated, on each of the gypsum powders.

### Example 5

A sample was prepared in the same manner as in Example 4 by formulating an admixture, except for applying a coating layer including an outer layer composed of a thermoplastic resin (polyol) having a low melting point and an inner layer in which 50 parts by weight of acetic acid, 30 parts by weight of magnesium salts, 5 parts by weight of hydrogenated polyterpene, and 1 part by weight of raffinose, with respect to 100 parts by weight of HPMCP, were formulated, on each of the gypsum powders.

### Example 6

A sample was prepared in the same manner as in Example 1 by formulating an admixture, except that smectite clay minerals were used as the expansive material instead of alginate.

### Example 7

A sample was prepared in the same manner as in Example 1 by formulating an admixture, except that the admixture was formulated to further include 1 part by weight of polyaspartate with respect to 100 parts by weight of blast furnace slag.

### Example 8

A sample was prepared in the same manner as in Example 1 by formulating an admixture, except that the admixture was formulated to further include 9 parts by weight of polyaspartate and 1 part by weight of abietic acid (in a 9:1 weight ratio) with respect to 100 parts by weight of blast furnace slag.

TABLE 3

| | | Exam- | Exam- | Exam- | Exam- | Exam- | Exam- | Exam- | Exam- | Test |
|---|---|---|---|---|---|---|---|---|---|---|
| Test item | Unit | ple 1 | ple 2 | ple 3 | ple 4 | ple 5 | ple 6 | ple 7 | ple 8 | Standard |
| Compressive | MPa | 52.6 | 53.2 | 52.9 | 53.1 | 52.4 | 45.7 | 46.5 | 50.9 | KS F |
| strength | | | | | | | | | | 2405 |
| (at 28 days) | | | | | | | | | | |
| Flow | mm | 185 | 180 | 180 | 180 | 185 | 180 | 195 | 195 | |
| Length change | (%) | 0.19 | 0.094 | 0.041 | 0.023 | 0.0047 | 0.21 | 0.0016 | 0.0011 | KS F |
| rate | | | | | | | | | | 2424 |
| Chloride ion | (10⁻¹² | 5.4 | 2.55 | 4.21 | 2.83 | 1.57 | 5.67 | 3.13 | 2.52 | ASTM C |
| diffusion | m²/sec) | | | | | | | | | 267 |
| coefficient | | | | | | | | | | |

From Table 3 and FIG. 1, it is seen that the compressive strength is smaller in the case of Example 6 than in the case of Example 1, which is determined to be because in the case of Example 6, the hydration reaction is hindered due to the adsorption of OH-during the moisture absorption process by the addition of smectite clay minerals, serving as the expansive material. On the other hand, it is seen that Example 1 is further advantageous in terms of compressive strength compared to the case of Example 6, which is determined to be because only cations are absorbed during the moisture absorption process with the addition of alginate serving as the expansive material. In addition, it is seen that the compressive strength is smaller in the case of Example 7 than in the case of Example 1, which is determined to be due to the segregation of materials and the like with the addition of the polyaspartate for improving workability and resistance to drying cracking. In the case of Example 8, which is to address such challenges in Example 7, it was determined that the problem with the decrease in strength is addressed by further adding abietic acid in addition to the polyaspartate.

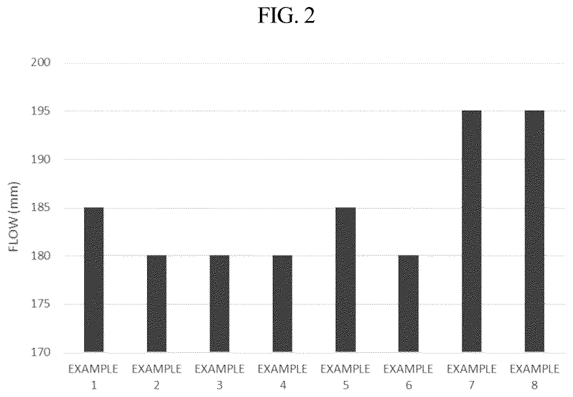

From Table 3 and FIG. 2, it is seen that Examples 7 and 8 are the best in terms of workability, which is determined to be because dispersibility is improved by further adding the polyaspartate.

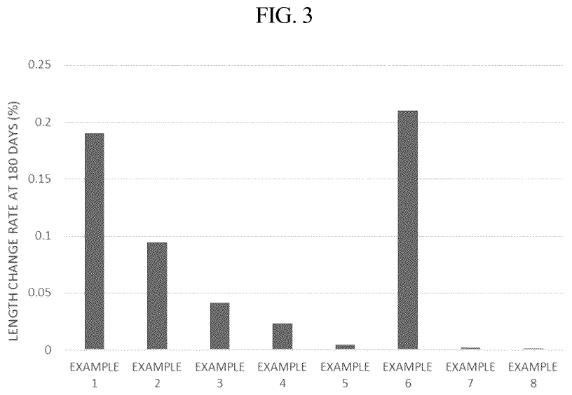

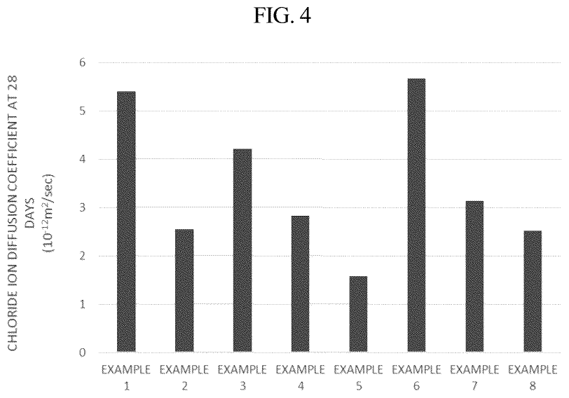

From Table 3, FIG. 3, and FIG. 4, it is seen that better effects in terms of crack resistance and chloride attack resistance are exhibited in the case of Example 2 than in the case of Example 1, which is determined to be because the self-healing efficacy is improved by further adding magnesia-carbon to Example 2.

In addition, it is seen that better effects in terms of crack resistance and chloride attack resistance are exhibited in the case of Example 3 than in the case of Example 1, which is determined to be because, now that Example 1 may be problematic with the self-healing efficacy failing to be exhibited afterward due to the reaction of the gypsum powder with moisture in the storage and formulation processes, such a problem is addressed by applying the coating layer on the gypsum powder in Example 3.

In addition, it is seen that better effects in terms of crack resistance and chloride attack resistance are exhibited in the case of Example 4 than in the case of Example 3, which is determined to be because the self-healing speed is promoted by further adding the hydrogenated polyterpene to the inner layer in the case of Example 4. Furthermore, it is seen that better effects are exhibited in the case of Example 5 than in the case of Example 4, which is determined to be because resistance to cracks on the interface of the crack healing parts is improved by further adding raffinose to the inner layer in the case of Example 5.

In addition, it is seen that better effects are derived in the case of Examples 7 and 8 than in the case of Example 1, which is determined to be due to the improvement in crack resistance, as mentioned above. In this case, it is also determined to be because resistance to drying cracking is improved by further adding the polyaspartate in the case of Example 7 and, especially in the case of Example 8, much better effects are seen to be exhibited, which is determined to be because the durability of paste is improved by further adding abietic acid in addition to the polyaspartate.

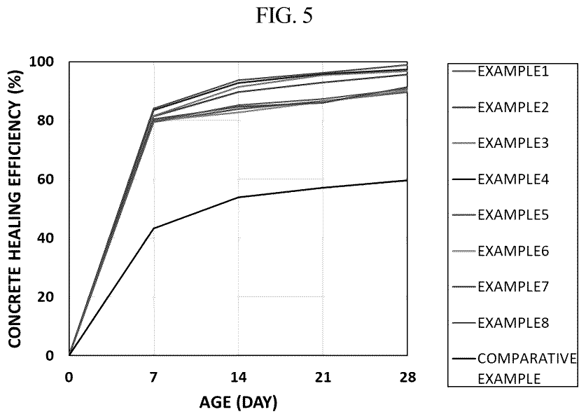

Experiments of crack healing efficiency were also performed on the comparative example and examples. The results thereof are shown in FIG. 5.

The crack healing efficiency refers to the degree to which the amount of water leaking through the crack surface decreases with varying ages, as measured by a constant head permeability test. FIG. 5 shows the crack healing efficiency for a crack width of 0.3 mm, measured 7 to 28 days (healing age of 7 to 28 days) after the occurrence of cracks.

After the occurrence of the cracks, Examples 1 to 8 show healing efficiencies in the range of 79.5% to 84.1% after 7 days and healing efficiencies in the range of 82.6% to 93.7% after 14 days. In addition, it is seen that the criteria of healing efficiency of 90% or higher is met at 28 days.

Next, for comparison between Examples 1 to 8, it is seen that a better effect is exhibited in the case of Example 2 than in the case of Example 1, which is determined to be because the admixture further includes magnesia-carbon.

In addition, it is seen that a better effect is exhibited in the case of Example 3 than in the case of Example 1, which is determined to be because, now that Example 1 may be problematic with the self-healing efficacy failing to be exhibited afterward due to the reaction of the gypsum powder with moisture in the storage and formulation processes, such a problem is addressed by applying the coating layer on the gypsum powder in Example 3.

In addition, it is seen that a better effect in terms of self-healing efficacy is exhibited in the case of Example 4 than in the case of Example 3, which is determined to be because the self-healing speed is promoted by further adding the hydrogenated polyterpene to the inner layer in the case of Example 4. Furthermore, it is seen that the best effect is exhibited in the case of Example 5, which is determined to be because resistance to cracks on the interface of the crack healing parts is improved by further adding raffinose to the inner layer in the case of Example 5.

In the meantime, the present disclosure also discloses a concrete water treatment structure and relates to a water treatment structure constructed using the composition of the present disclosure mentioned above.

Such a concrete water treatment structure includes water treatment structures constructed by assembling precast concrete panels using the composition of the present disclosure mentioned above. There are various known techniques for structures formed through the assembly of such precast concrete panels, and examples thereof include double-wall or single-wall construction methods.

What is claimed is:

1. A concrete composition for a water treatment structure having self-healing and waterproofing capabilities, the concrete composition comprising:
a cement; and
a self-healing admixture comprising blast furnace slag, fly ash, an expansive material, and gypsum powder.

2. The concrete composition of claim 1, wherein the self-healing admixture further comprises magnesia-carbon.

3. The concrete composition of claim 1, wherein a coating layer is applied on an outer periphery of the gypsum powder, and
the coating layer comprises:
an outer layer comprising a thermoplastic resin having a low melting point; and
an inner layer comprising hydroxypropyl methylcellulose phthalate (HPMCP), acetic acid, a magnesium salt, and hydrogenated polyterpene.

4. The concrete composition of claim 3, wherein the inner layer further comprises raffinose.

5. The concrete composition of claim 1, wherein the expansive material is a smectite clay mineral.

6. The concrete composition of claim 1, wherein the expansive material is a polyanionic polymer.

7. The concrete composition of claim 1, wherein the self-healing admixture further comprises polyaspartate.

8. The concrete composition of claim 7, wherein the self-healing admixture further comprises abietic acid.

9. A concrete water treatment structure using the concrete composition of claim 1.

10. The concrete water treatment structure of claim 9, wherein the concrete water treatment structure is constructed by assembling a precast concrete panel using the concrete composition.
